(19) United States
(12) Patent Application Publication
(10) Pub. No.: US 2018/0327285 A1
(43) Pub. Date: Nov. 15, 2018

(54) AQUEOUS DEGREASING WASHER

(71) Applicants: MICHELE BASSAN, CHIOGGIA (IT); ROBERTO SANDONA', SPINEA (IT); ENRICO SANDONA', SANTA MARIA DI SALA (IT); ENNIO DAL MORO, CHIOGGIA (IT)

(72) Inventors: MICHELE BASSAN, CHIOGGIA (IT); ROBERTO SANDONA', SPINEA (IT); ENRICO SANDONA', SANTA MARIA DI SALA (IT); ENNIO DAL MORO, CHIOGGIA (IT)

(21) Appl. No.: 15/731,828

(22) PCT Filed: Feb. 17, 2016
(86) PCT No.: PCT/IT2016/000052

§ 371 Date: Aug. 8, 2017

(30) Foreign Application Priority Data
Feb. 26, 2015 (IT) TV2015A000036

(51) Int. Cl. C02F 1/461; C02F 1/48; B08B 3/10

(52) U.S. Cl. CPC C02F 1/4618; C02F 1/005; B08B 3/10; C02F 1/485

(57) ABSTRACT

The invention is composed of a cleaning/degreasing machinery which can be used without chemical additives because it works only with treated domestic water. The aqueous degreasing washer is made up by a duct 14 as shown in (Table 1) that allows the manual or automatic load of the water of the tanks 1 and 2 shown in (Table 1). The duct 10 is composed of two detached sections 10A and 10B and the water runs separately in the tanks 1 and 2 and reaches the solenoid valve through the ducts 10′ and 10″ arriving separately at the exit 15 (Table 1). The exit can be connected to household electrical appliances, industrial appliances or to hand spray guns connected to the 10′ and 10″ connection pipes. The energy-management system of the device is carried out by the terminal block connector using an interface 13 used to communicate with household electrical appliances, industrial appliances or with a simple circuit. In order to carry out the degreasing, the releasing waters from the device will have to combine equally on the surface that will have to be treated so as to remove the animal, the vegetable and the synthetic fats without using chemical products, detergents or other substances. Doing so, the environmental impact will be considerably reduced. The degreasing increases as the temperature, the pressure of the water and the mechanical action increases. The treated surfaces result to have no unpleasant smell. Depending on the household electrical appliance to which the device will interface without modifying the functioning, the input and management controls may change.

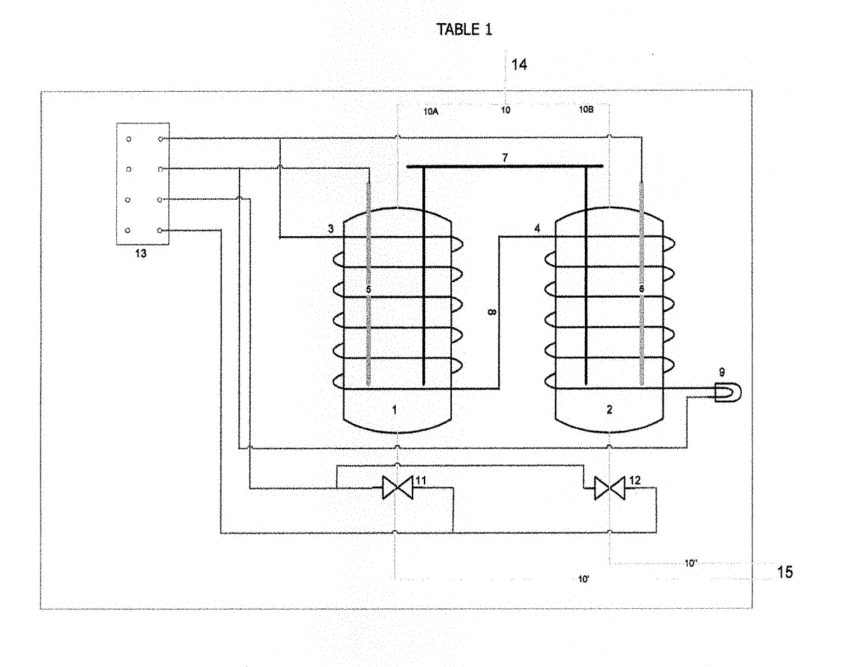

The invention is composed of a cleaning/degreasing machinery which can be used without chemical additives because it works only with treated domestic water.

The device degreases and cleans all the surfaces dirty of animal, vegetable and synthetic fats without using chemical products, detergents or other substances. Doing so, the environmental impact will be considerably reduced.

The degreasing increases as the temperature and the releasing pressure increases.

Currently there are several cleaning systems on the market:
Degreasing systems/chemical detergents;
Cleaning systems with mechanical action;
Cleaning systems with thermal action;

In detail:
The degreasing systems/chemical detergents, used nowadays, need dangerous manufacturing of the raw materials they are made of. The user has to be careful when using them since they produce V.O.U. (Volatile Organic Compounds), hazardous for health and for the environment as it is difficult to dispose of waste.
Cleaning systems with mechanical action are those systems that besides using water and detergents there is a mechanical action of attrition, pressure or something else in order to improve the cleaning action. These types of systems' disadvantages, besides those from the chemical systems mentioned above, are the notable consumption of energy.
Cleaning systems with thermal action as the steam machines that use pressurised water tank, high temperatures and a notable consumption of energy.

The aqueous degreasing device is different from the other degreasing systems used nowadays because there is no chemical waste, except for the melted fat, and the there is an insignificant consumption of energy. The device has the right size depending on the household/industrial electric appliance connected. The connection pipes 10′ and 10″ connected to the exit 15 of the device can be connected to household or industrial electric appliances, spray gun nozzles, hand spray guns or pumps to increase the pressure of the water that comes out. Anyway the degreasing of the device is functional when the waters blend in equal parts when reaching the dirty surface because it has limited lifetime. The temperature that the water has, the mechanical action produced by the brushes or by the pressure of the device, improves the cleaning action;

All the parts the device is made up of are represented in “Table 1”. The aqueous degreasing washer is made up by a duct 14 as shown in (Table 1) that allows the manual or automatic load of the water of the tanks 1 and 2 shown in (Table 1). The duct 10 is composed of two detached sections 10A and 10B and the water runs separately in the tanks 1 and 2 and reaches the solenoid valve through the ducts 10′ and 10″ arriving separately at the exit 15 (Table 1).

The exit can be connected to household electrical appliances, industrial appliances, to spray gun nozzles, to hand spray guns or pumps. The electrical network is composed of: a terminal block connector using an interface 13 used to communicate with household electrical appliances, industrial appliances or with a simple circuit (Table 1) (to control the solenoid valve and the starting of the device), electrical conductor (R.E.M.E.) 7; electrodes (metallic conductor) 5 and 6; solenoid 3 and 4. Solenoid valves 11 and 12. Connection between the solenoids 8. Load 9. Two water tanks 1 and 2. Connection pipes 10. Exit 15 (Table 1) can be connected to household electrical appliances, industrial appliances or spray gun nozzles, hand spray guns or water vaporization pumps. The electrodes 5 and 6 are connected to the terminal block connector that uses interface 13. The solenoids 3 and 4 are connected in series through the connection 8 to the load 9 which will have to be connected to the terminal block connector that uses interface 13. Also the solenoid valves 11 and 12 will have to be connected to the terminal block too.

Depending on the type of household electrical appliance, industrial appliance or gun nozzles connected to the exit 15 (Table 1), the device can be charged with battery or with the domestic plug.

The voltage of the device can vary from a minimum of 3.6V to a maximum of 48V uninterrupted (supply of the electrodes 5 and 6 and of the solenoids 3 and 4), whilst the supply of the solenoid valves depends on the type of user that s connected to the device. After the starting of the device, which is the subject of the patent, follows the activation of the load 9, here is where the ionization/charging of the water in the tanks 1 ad 2 start. This is made possible by the electrodes 5, 6 and electrical conductor 7 (R.E.M.E.) which is the fundamental element in treating the water contained in the tanks and in the magnetization through solenoids 3 and 4. It depends on the household electrical appliance, industrial or gun nozzles connected to the exit but, the solenoid valves 11 and 12 starts to work and the water contained in the tanks 1 and 2 goes through the connection pipes 10′ and 10″ and it runs to the exit 15 of the device. The water that comes from the tanks 1 and 2 combining and mixing when reaching the dirty surface starts to clean/degrease through the magnetization of the water coming from the solenoids 3 and 4. This process has a lazy battery effect on the treated surface which means the surface polarizes and the dirt sticks less to the surface previously treated. The device can be attached to all those machineries and systems that use water to clean/degrease. The degreasing action of the device, subject of the patent, is efficient also with low temperature.

1. Aqueous degreasing washer composed of a first tank 1 and a second tank 2 characterized by:
a first entering duct 14
a second duct composed of two separated sections 10A and 10B,
a third duct 10′ which goes out from the tank 1,
a fourth duct 10″ which goes out from the tank 2
10′ and 10″ are separated ducts,
at least an electrode 5 immersed in tank 1,
at least one electrode 6 immerse in tank 2,
a electrical conductor 7 linked and immerse in tanks 1 and 2.

2. Device as from claim 1 characterized by the tanks 1 and 2 which are covered by the solenoids 3 and 4.

3. Aqueous degreasing washer as from previous claims characterized by a third duct 10′ and the fourth 10″ which are separated in the exit 15.

4. Aqueous degreasing washer as from previous claims characterized by electrical conductor duet 7 which electrically closes the circuit between tanks 1 and 2.

5. Aqueous degreasing washer as from previous claims characterized by the electrodes 5 and 6 which are connected to the terminal block connector that uses interface 13.

6. Aqueous degreasing washer as from previous claims characterized by a solenoid valves 11 and 12 that have to be connected to the terminal block connector that used interface 13.

7. Aqueous degreasing washer as from previous claims characterized by the solenoid valves 11 and 12 connected through the pipes 5 connected to 10 and to the tanks 1 and 2 which keep the water separated till it reaches exit 15.
